(19) United States
(12) Patent Application Publication
(10) Pub. No.: US 2006/0102544 A1
(43) Pub. Date: May 18, 2006

(54) Fluid magnetization device

(76) Inventor: Hsiang-Lan Chiu, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/986,093

(22) Filed: Nov. 12, 2004

(51) Int. Cl. C02F 1/48

(52) U.S. Cl. 210/222; 210/695

(57) ABSTRACT

A fluid magnetization device includes a first box and a second box, a pair of permanent magnets and a washer. The second box and the washer are sized to be inserted into the first box, and the permanent magnets are sized to be inserted into the second box and the washer, respectively. The first box and the second box engage with a pipeline. The magnetic field caused by the two permanent magnets magnetizes the fluid flowing the pipeline.

### FIELD OF THE INVENTION

This invention relates to a fluid magnetization device, and more particularly to a pair of boxes adapted to adjust their connecting space for pipelines of different sizes to go through the space for magnetization of the fluid flowing through the pipeline.

### BACKGROUND OF THE INVENTION

It is popular for consumers to use magnetized fluid as drinking water or lubricant of their machines. This magnetization process requires a pipeline going through a magnetization device. The magnetization device is a set device with a space at the center for the pipeline to insert through.

However, the current magnetization devices are all fixed in the space, therefore, if the pipeline has a different size, the magnetization device cannot accommodate the pipeline. It is required to replace another magnetization device, which increases the cost and time of production.

### SUMMARY OF THE INVENTION

It is the primary objective of the present invention to provide a fluid magnetization device, which is applied to accommodate pipelines of different sizes.

It is another objective of the present invention to provide the fluid magnetization device, which is easy to adjust its space for pipelines of different sizes.

It is a further objective of the present invention to provide the fluid magnetization device, which is more secure and safe in use.

### BRIEF DESCRIPTION OF THE DRAWINGS

FIG. 1 is an exploded view of the present invention;

FIG. 2 is an exploded view of the present invention applied to a pipeline;

FIG. 3 is a cross-sectional view of the present invention incorporated with the pipeline; and

FIG. 4 is a view similar to FIG. 3, having another pipeline in a different size.

### DETAILED DESCRIPTION OF THE PREFERRED EMBODIMENT

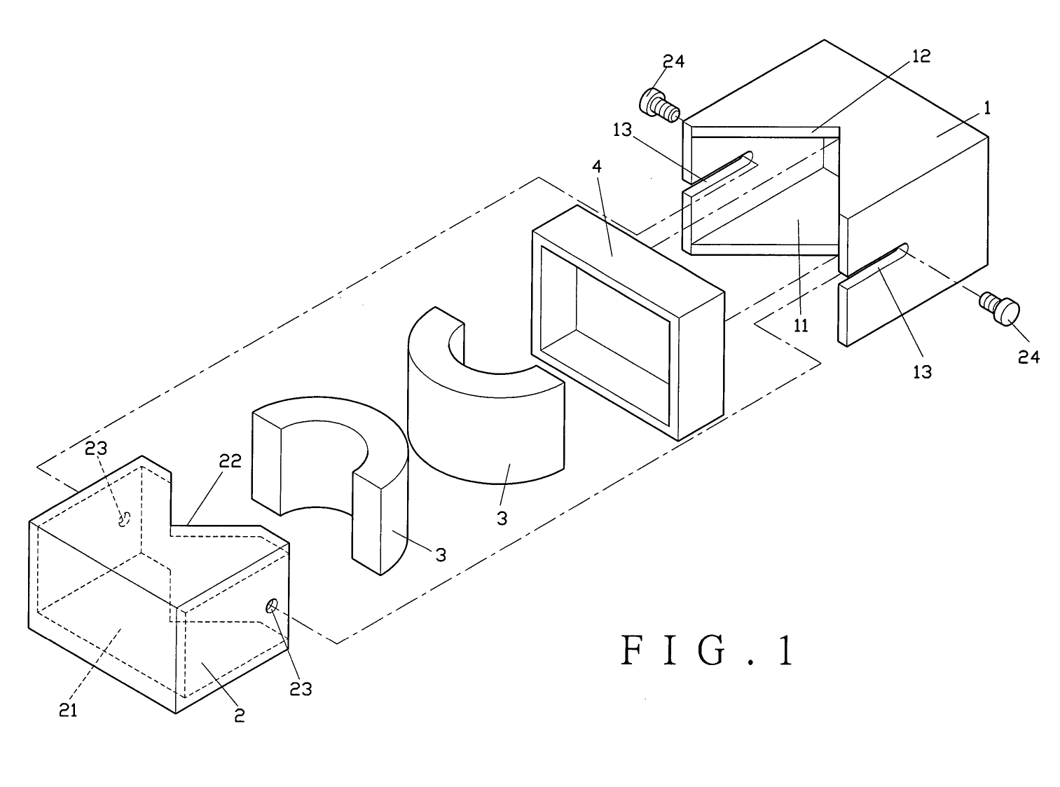

As shown in FIG. 1, the present invention comprises a first box 1, a second box 2, a pair of permanent magnets 3 and a washer 4.

The first box 1 has a receptacle 11 with a pair of V-shaped openings 12 at respective wide sides and a pair of slots 13 at respective narrow sides.

The second box 2 has the same shape as the first box 1 with an outer diameter slightly smaller than the inner diameter of the first box 1 so as to insert into the first box 1. The second box 2 has a receptacle 21 with a pair of V-shaped openings 22 at respective wide sides and a pair of threaded holes 23 at respective narrow sides for a pair of bolts 24 to insert and secure therein.

The two permanent magnets 3 are secured in the receptacles 11 and 21 of the first box 1 and the second box 2, respectively. Each permanent magnet 3 is in semi-circular shape and has an outer diameter equal to the inner diameter of the second box 2.

The washer 4 is made of anti-magnet material to receive one of the permanent magnets 3 therein. The washer 4 with the permanent magnet 3 is inserted into the receptacle 11 of the first box 1.

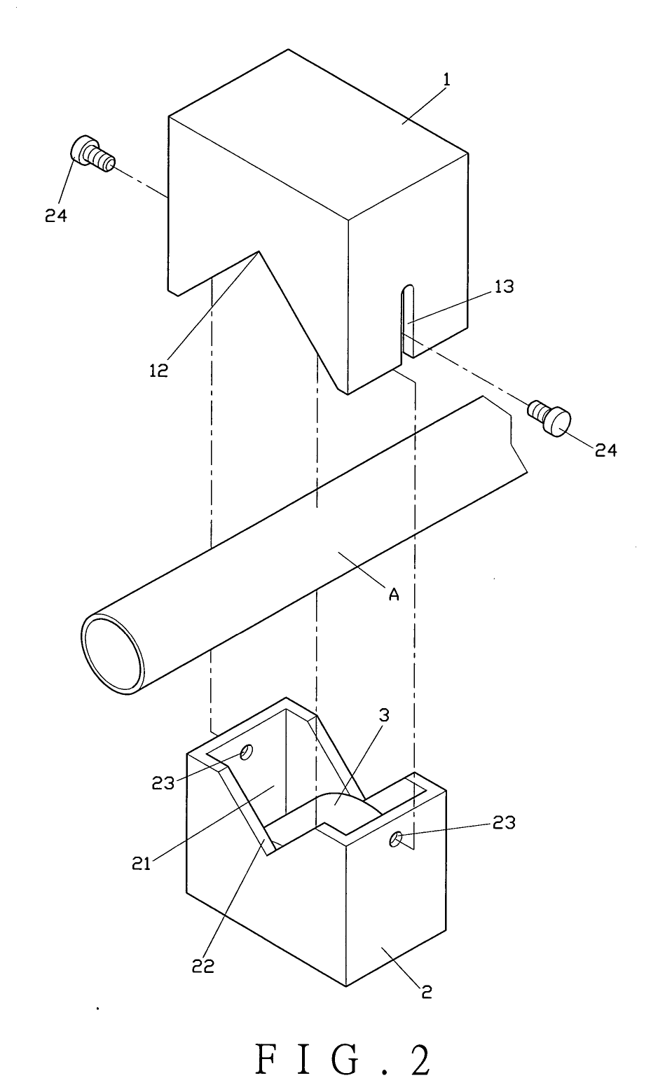

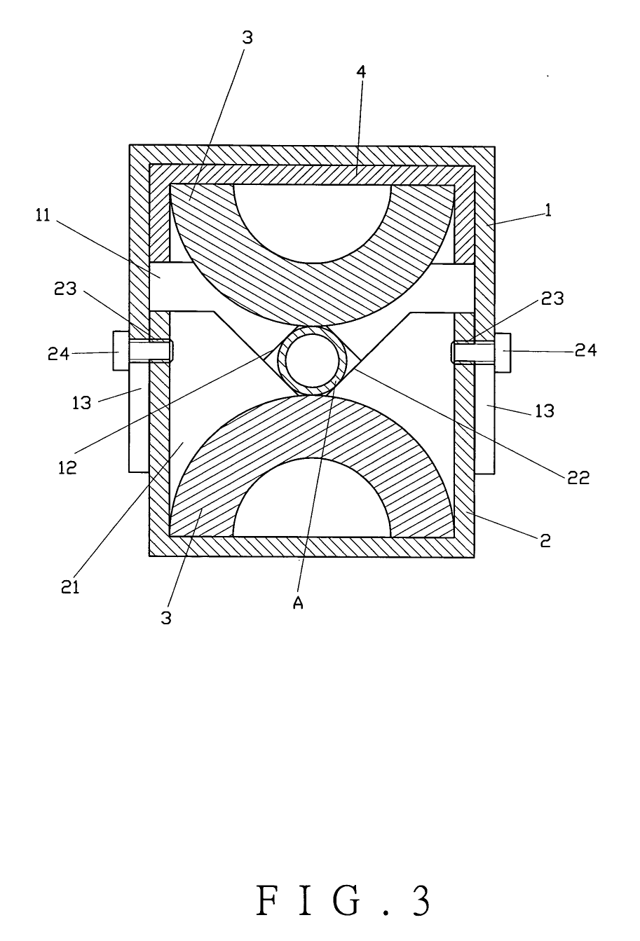

To assemble the present invention, as shown in FIGS. 2 and 3, place the pair of permanent magnets 3 into the first box 1 and the second box 2. Due to the size, one of the permanent magnets 3 is able to insert into the second box 2, whereas the size of the permanent magnet 3 is smaller than the inner diameter of the first box, the washer 4 is placed in the first box 1 with the permanent magnet 3 inserting into the washer 4. A pipeline A is placed between the openings 12 and 22 of the first box 1 and second box 2. The two permanent magnets 3 engage with the pipeline A. The bolts 24 are inserted through the slots 13 of the first box 1 and the threaded holes 23 of the second box 2 to secure the pipeline A at place. When fluid flows through the pipeline A, the magnetic field caused by the two permanent magnets 3 magnetizes the fluid.

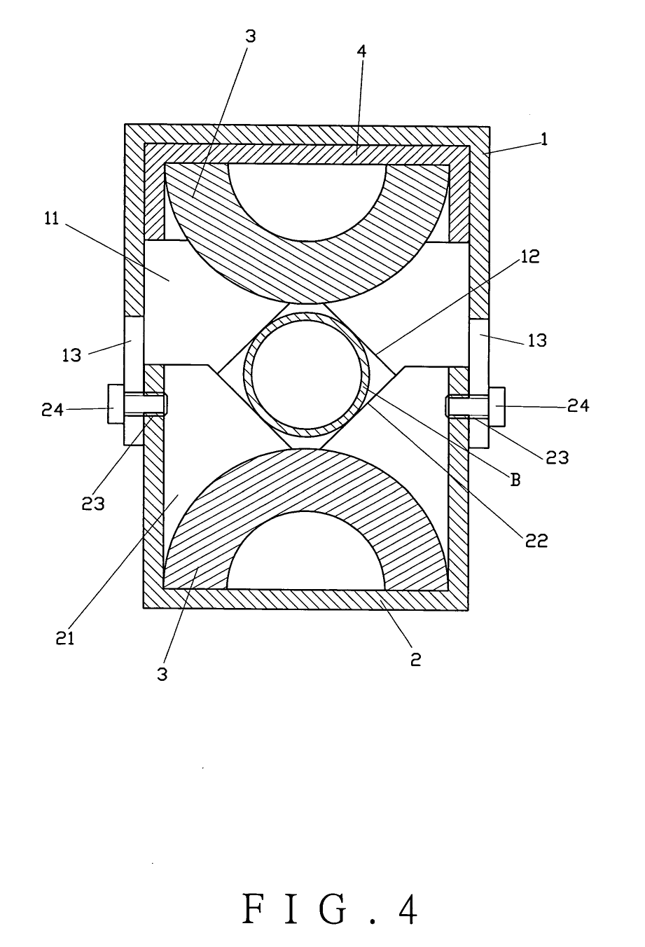

As shown in FIG. 4, when the present invention is applied to another pipeline B in a different size, simply adjust the bolts 24 to move the first box 1 and the second box 2 for the pipeline B to go through the openings 12 and 22, and then secure the bolts 24.

I claim:

1. A fluid magnetization device comprising:
a first box having a receptacle and a pair of openings;
a second box having an outer diameter slight smaller than an inner diameter of said first box so as to insert into said receptacle of said first box, said second box having a receptacle and a pair of openings, and
a pair of permanent magnets deposited in said receptacles of said first box and said second box, respectively;

2. The fluid magnetization device, as recited in claim 1, wherein said first box comprises a pair of slots at two sides, and said second box comprises a pair of threaded holes at two sides for a pair of bolts to insert and secure therein.

3. The fluid magnetization device, as recited in claim 1, wherein said permanent magnets are in semi-circular shape, and each permanent magnet has an outer diameter equal to an inner diameter of said second box for insertion one of said permanent magnets into said second box, while another said permanent magnet is inserted into a washer and placed into said first box together.
